(19) United States
(12) Patent Application Publication
(10) Pub. No.: US 2021/0243770 A1
(43) Pub. Date: Aug. 5, 2021

(54) METHOD, COMPUTER PROGRAM AND CIRCUITRY FOR MANAGING RESOURCES WITHIN A RADIO ACCESS NETWORK

(71) Applicant: Nokia Solutions and Networks Oy, Espoo (FI)

(72) Inventors: Horst Roessler, Filderstradt (DE); Rupert Rheinschmitt, Korntal-Munchingen (DE); Ashraful Alam, Stuttgart (DE)

(73) Assignee: Nokia Solutions and Networks Oy, Espoo (FI)

(21) Appl. No.: 17/050,061

(22) PCT Filed: May 8, 2018
(86) PCT No.: PCT/EP2018/061926

§ 371 Date: Oct. 23, 2020

(51) Int. Cl. H04W 72/08; H04W 72/02; H04W 72/04

(52) U.S. Cl. CPC H04W 72/087; H04W 72/0493; H04W 72/02

(57) ABSTRACT

A method, computer program and circuitry configured to manage resources within a radio access network. The managing of the resources is performed by distributing at least some of a plurality of resources into a plurality of pools of resources, each of the pools of resources being configured to provide data handling for a different predetermined function, each predetermined function relating to a particular service provided by the radio access network.

### TECHNOLOGICAL FIELD

Various example embodiments relate to a method, computer program and circuitry for managing resources within a radio access network.

### BACKGROUND

With the advent of 5G there is an increasing number of different services provided to an increasing number of users. The latency requirements and functionality of these different services is very diverse. In order to provide sufficient resources, cloud computing has been used. In cloud computing a shared pool of configurable computing resources is provided as a centralised resource. However, 5G communication protocols have different resource requirements compared to general purpose applications, and may require a minimum performance to meet the latency and throughput requirements. Thus, dedicated hardware is still often used to provide many of the services.

It would be desirable to effectively and efficiently provide resources to support diverse radio access network communications with different latency and throughput requirements.

### BRIEF SUMMARY

According to a first aspect there is provided a method of managing resources within a radio access network. The method comprises: distributing at least some of a plurality of resources into a plurality of pools of resources, each of said plurality of pools of resources being configured to provide data handling for a different predetermined function, each predetermined function relating to a particular service. The services may be services supplied by the radio access network. The method may further include managing at least some of the pools of resources in dependence upon requirements of the corresponding service. In some cases the service requirements may be related to a QoS (quality of service) regime that is established for the different services by the network.

The inventors recognised that radio access networks are handling increasingly diverse tasks with correspondingly diverse performance requirements. Distributing an available set of resources into a plurality of pools of resources each configured to provide data handling for a different predetermined function relating to a particular service allows resources to be efficiently managed. Latency, load and performance requirements of the network are often service dependent and thus, managing the resources provided to the network as pools of resources for a function related to a particular service allows appropriate resources to be assigned to each function and service.

Furthermore, updates will also generally be function and service dependent and thus, managing the resources on a function and service basis allows these updates to be provided without affecting the whole network. Where a function or service needs correcting or updating, having the resources arranged as pools of resources for a particular function of a service may allow the relevant pool to be amended without affecting other resources.

In summary, managing resources by managing individual pools configured to perform functions related to a particular service is an effective way of managing the resources in a compartmentalised way that allows control, sharing and updating of resources to be managed effectively.

In some embodiments, the method further comprises distributing user requests to respective ones of said plurality of pools in dependence upon said service requested and said function to be performed.

The distribution of resources to pools to perform a particular function means that user requests are distributed to a particular pool in dependence upon the service and function.

In some embodiments, said predetermined function comprises an autonomous or semi-autonomous function processing for which can be performed with low interaction with other resources.

An effective way of distributing the resources to provide data handling for a particular function is to select the function to be an autonomous or semi-autonomous function. In this regard functions with high cohesion that are loosely coupled to other functions and can operate relatively independently of other functions are viewed as autonomous or semi-autonomous. Such properties of these functions makes their separate management and control simpler and provides for a compartmentalised system.

In some embodiments, each of said pools comprise at least one resource configured to provide said predetermined function on demand.

The pools of resources may comprise a number of things but in some embodiments the resources may comprise pre-instantiated executable files such as virtual machines or containers which are ready on demand to provide the function.

In some embodiments, at least one of said at least one resource comprises a special purpose processor configured to provide said predetermined function.

Although, it may be appropriate for some of the functions to be provided by software and in some cases by a virtual machine, in other embodiments it may be appropriate to provide at least some of the resources by hardware and perhaps by a special or single purpose processor configured to provide the predetermined function. In some cases where particularly low latency is required then it may be more appropriate to provide a hardware solution for the function.

In some embodiments, said managing step further comprises, in response to detecting or predicting changes in loading of said service on said network switching at least one resource within a pool configured to provide data handling for a predetermined function related to said service between an activated state in which said resource is operational and performing said predetermined function and a deactivated state where said resource is available to the pool on request but is not currently operational.

A further advantage of pooling resources in this way is that changes in loading in the system are often service related. This allows resources currently allocated to a particular function to be activated or deactivated as load requirements change or are predicted to change. In this way, an efficient use of the resources is provided which can be updated according to requirements and can in many cases be more accurately predicted.

In some embodiments, the method comprises allocating at least one of processor, communication and data storage resource to said at least one resource on activation of said at least one resource and releasing said allocated at least one of processor, communication and data storage resource on deactivation of said at least one resource.

As noted previously, some of the resources may be pre-instantiated ready to start executable files, microservices or functional blocks and the activation or deactivation of these resources allows the processor, communication or data storage resources that they use during operation to be released, allowing them to be allocated to other pools or just to be released to the pool for use later as loads change. It should be noted that where the resource is in the form of a pre-instantiated executable file then there may be a single copy of it within the pool and on activation it may be cloned and the appropriate processing and data storage resources allocated for its use or there may be several copies and a copy may be taken on activation and again the appropriate processing and data storage resources allocated for its use.

In some embodiments, in response to a request for updating said predetermined function, the method comprises updating said resource configured to perform said predetermined function when said resource is in said deactivated state.

One further advantage of embodiments is that where a function or service is to be updated, then rather than having to use system downtime to update or repair the system, it may be that the function or service can be updated during runtime. As the system is separated into different pools of resources that are related to particular services, then there may be times when a particular service is not required and at this point an update or repair on just the pool of resources assigned to this service could be provided.

Furthermore, where the resource providing a function is a MicroService or instantiated executable file, then an update may be performed while this function is still being provided. In this case, when the demand for the service is low and a portion of the resource has been deactivated, then the file when it is in a deactivated state and not currently operational, can be amended without affecting the operation of the whole system. In this way the update can be seamless and system downtime is reduced or even eliminated.

It should be noted that where the resources are provided as an instantiated executable file then where there are multiple copies of the file available then when a copy is deactivated it can be updated and this can be done in turn to each copy of the file. Where the system is such that the file is cloned then when that service is not required for a particular time period then the copy stored can be updated and future clonings will clone the updated copy.

In some embodiments, the method comprises a further step of grouping at least some of said pools into groups of pools of resources.

It may be advantageous to group pools of resources together. In this regard, it has been noted that a resource is configured to provide data handling for a predetermined function and this function may be autonomous or semi-autonomous such that it has low interaction with other resources. In some cases a group of functions may act together in an autonomous or semi-autonomous way. They may have tight couplings with each other but loose coupling with other functions. Where there is tight coupling between a set of the functions then it may be advantageous if these pools of resources performing this set of functions are grouped together such that a group of resources has high cohesion. Such a group can be allocated physically or logically close to each other and can be managed together. In this regard, it is likely that the resource requirements will rise and fall as a group as load requirements for the functions will be associated and thus when predicting it is useful to analyse the group together and when providing resources it is useful to provide them as a group.

In some embodiments, at least some of said pools are grouped into groups of pools of resources providing a same service, each pool providing a different protocol layer of said service.

When grouping the pools of resources it may be convenient to group them in a group that provides a same service. The load on a network may vary in a difficult to predict manner, however the load of a particular service may be easier to predict and thus, grouping pools of resources by service may make providing a predictable amount of resource easier to manage.

In some embodiments, at least some of said pools are grouped into groups of pools of resources providing a same service, each pool providing a different function of said service.

In some embodiments, at least some of said pools are grouped into groups of pools of resources according to a latency requirement of said service, pools of resources with similar latency requirements being grouped together.

As noted previously, as the network provides increasingly diverse functionality, there are increasingly diverse latency requirements across the network. It may be convenient to group pools of resources with similar latency requirements together. This grouping may be a logical grouping and/or it may be a physical grouping.

In some embodiments, at least some of said pools are grouped into groups of pools of resources with a same FFT length.

As noted previously services provided by communication network have increasingly diverse latency requirements. Modern 5G provides protocol stacks with different FFT lengths, shorter FFT lengths being assigned to services with lower latency requirements. It is important when managing resources for communication systems that certain latency requirements are met for certain services. As there is already a division into different length FFTs then this can be used in embodiments, to manage resources according to FFT length and thus, prioritise the lower latency resources for these functions.

In some embodiments, at least some of said pools are grouped into groups of pools of resources using a same data coding scheme.

In addition to diverse latency requirements, services provided by a network may also have different error rate requirements. In some embodiments, this is addressed by establishing a variety of coding schemes that can be flexibly adapted to changing air interface conditions. Resources may be grouped according to the data coding scheme provided, such data coding schemes may include low density parity check codes (LDPC) or polar codes for example. Services with different error rate requirements could be assigned to different resources pooled and grouped in this way. Furthermore, updates to a particular coding scheme may be more easily managed where the resources using the schemes are grouped together in this way.

In some embodiments, at least some of said groups of pools are located on a same central processing unit.

In some embodiments, groups of pools with a low latency requirement are located in a front end unit and groups of pools with a higher latency requirement are located in an edge cloud unit.

Resources for radio access networks can be provided within the cloud or within the front end closer to the radiohead. The latency associated with the location of these resources is different and thus, grouping pools of resources according to latency allows their location to be selected in a manner that helps provide the required latency and makes efficient use of the resources available. It should be noted that the front end unit may also be termed gNB-DU (Gigabit or new generation Node-B distributed unit) and the cloud edge unit as gNB-CU (Gigabit or new generation Node-B central unit).

In some embodiments, said method comprises a step of predicting future resource requirement for at least some of said pools.

It is convenient when predicting future resource requirements if pools for which predictions are made are grouped in a way that enables improved prediction. For example, where resources are allocated according to service then predicting the load of the service may be simpler than predicting the load in general on a network. Furthermore, where the groups are in the same protocol layer then these groups may have similar functionality and similar scaling as user numbers change. Thus, again predicting loads for these may be simpler to do on a group basis.

In some embodiments, said step of predicting is performed for said at least one of said groups of said pools.

In some embodiments, in response to said step of predicting indicating that the predicted usage of processing resources within one of said pools is to fall below a predetermined threshold changing at least one of said processing resources within said pool from an activated state in which said resource is operational and performing said predetermined function and a deactivated state where said resource is available to the pool on request but is not currently operational.

Providing improved prediction also allows the resources to be activated and deactivated more effectively. Although when deactivated the resource may be ready to use, any processing, data storage or communication resource required for its operation is released providing efficient use of such resources.

In some embodiments, in response to said step of predicting indicating that the predicted usage of processing resources within one of said pools is to rise above a predetermined threshold changing at least one of said processing resources within said pool from a deactivated state where said resource is available to the pool on request but is not currently operational to an activated state in which said resource is operational and performing said predetermined function.

In some embodiments, the method comprises an initial step of determining processing, data storage and communication resources available to said network and including said determined available resources in said plurality of resources.

Prior to distributing the resources to the different resource pools, the method may first determine what resources are available and at least some of these resources are distributed between the pools.

In some embodiments, the method comprises receiving information from a provider of services indicating services and performance requirements for said services that said provider seeks to provide from said radio access network; distributing said plurality of resources into pools to provide functions related to said services in dependence upon the received information.

The services to be provided by the radio access network may be indicated by a provider and in response to this the method may manage the resources to provide the appropriate level of resource for each service. In this regard the method may determine which functions are autonomous or semi-autonomous, that is which have the lower number of interactions with other functions. The method may select functions in this way as functions to which pools of resources are provided.

A second aspect provides circuitry providing resources within a radio access network architecture. The circuitry comprises: a plurality of resources said resources including general purpose processors configured to provide processing resources for said radio access network. The circuitry comprises resource managing circuitry configured to distribute at least some of said plurality of resources into a plurality of pools of resources, each of said plurality of pools of resources being configured to provide data handling for a different predetermined function, each predetermined function relating to a particular service and to manage said resources distributed to at least some of said plurality of pools in dependence upon requirements of said corresponding service.

The resources may be logically divided into pools allowing them to be separately managed. User requests to perform a particular function may be routed to a corresponding pool of resources. Managing resources of the radio access network in separate pools related to a particular function and service, allows the resource management to be simpler and more predictable and allows the differing latency requirements and updating requirements of different services to be effectively managed. The pooling of resources on a function basis allows functions with higher performance requirements to have resources of a lower latency allocated to them.

Furthermore, the assigning of additional resources and the updating of functions can be managed in a compartmentalised way on a function and service basis.

In some embodiments, the circuitry further comprises distributing circuitry configured to distribute user requests to respective ones of said plurality of pools of resources in dependence upon said service requested and said function to be performed.

In some embodiments, said predetermined function comprises an autonomous or semi-autonomous function processing of which can be performed with low interaction with other resources.

In some embodiments, each of said pools comprise at least one resource configured to provide said predetermined function on demand.

In some embodiments, at least one of said at least one resource comprises a pre-instantiated executable file configured on execution to provide said predetermined function.

In some embodiments, at least one of said at least one resource comprises a special purpose processor configured to provide said predetermined function.

In some embodiments, the circuitry comprises load balancing circuitry configured to switch at least one resource within a pool between an activated state in which said resource is operational and performing said predetermined function and a deactivated state where said resource is available to the pool on request but is not currently operational.

In some embodiments, said load balancing circuitry is configured to allocate at least one of processor, communication and data storage resource to said at least one resource on activation of said at least one resource and to release said allocated at least one of processor, communication and data storage resource on deactivation of said at least one resource.

In some embodiments, the circuitry comprises updating circuitry configured in response to a request for updating said predetermined function to update said resource configured to perform said predetermined function when said resource is in said deactivated state.

In some embodiments, said resource managing circuitry is further configured to group at least some of said pools into groups of pools of resources.

In some embodiments, at least some of said pools are grouped into groups of pools of resources providing a same service, each pool providing a different protocol layer of said service.

In some embodiments, at least some of said pools are grouped into groups of pools of resources providing a same service, each pool providing a different function of said service.

In some embodiments, at least some of said pools are grouped into groups of pools of resources according to a latency requirement of said service, pools of resources with similar latency requirements being grouped together.

In some embodiments, at least some of said pools are grouped into groups of pools of resources with a same FFT length.

In some embodiments, said circuitry comprises at least one central processing unit, at least some of said groups of pools are located on a same central processing unit.

In some embodiments, said circuitry is located on a front end unit of said radio access network.

In some embodiments, said circuitry is located on a cloud edge of said radio access network.

In some embodiments, said circuitry is distributed between said front end unit and said cloud edge of said radio access network, groups of pools with a lower latency requirement being located in said front end unit and groups of pools with a higher latency requirement are located in said edge cloud unit.

In some embodiments, said circuitry further comprises prediction circuitry configured to predict future resource requirement.

In some embodiments, said prediction circuitry is configured to predict future resource requirement for at least one of said pools.

In some embodiments, said prediction circuitry is configured to predict future resource requirement for at least one of said groups of said pools.

In some embodiments, in response to said prediction circuitry indicating that the predicted usage of processing resources within one of said pools is to fall below a predetermined threshold said resource management circuitry is configured to change at least one of said processing resources within said pool from an activated state in which said resource is operational and performing said predetermined function to a deactivated state where said resource is available to the pool on request but is not currently operational.

In some embodiments, in response to said prediction circuitry indicating that the predicted usage of processing resources within one of said pools is to rise above a predetermined threshold, said resource management circuitry is configured to change at least one of said processing resources within said pool from a deactivated state where said resource is available to the pool on request but is not currently operational to an activated state in which said resource is operational and performing said predetermined function.

In some embodiments, said resource managing circuitry is configured to determine processing, data storage and communication resources available to said network and to include said determined available resources in said plurality of resources.

In some embodiments, said resource managing circuitry is configured to receive information from a provider of services indicating services and performance requirements for said services that said provider seeks to provide from said radio access network; and to distribute said plurality of resources into pools to provide functions related to said services in dependence upon the received information.

A third aspect provides a computer program comprising instructions for causing an apparatus to perform steps in a method according to a first aspect.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

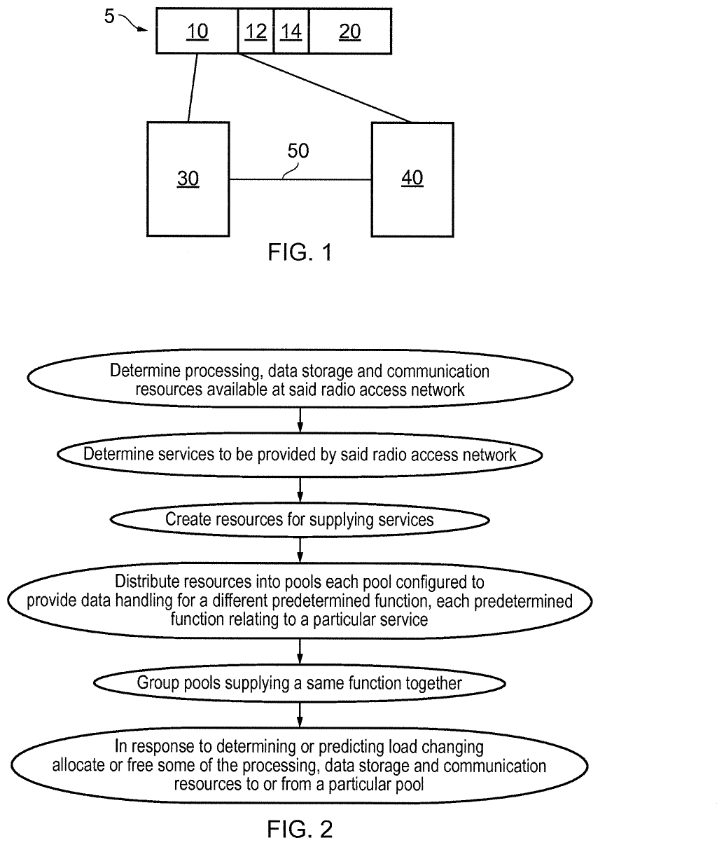

FIG. 1 schematically illustrates circuitry according to an example embodiment;

FIG. 2 shows a flow diagram illustrating steps in a method performed according to an example embodiment;

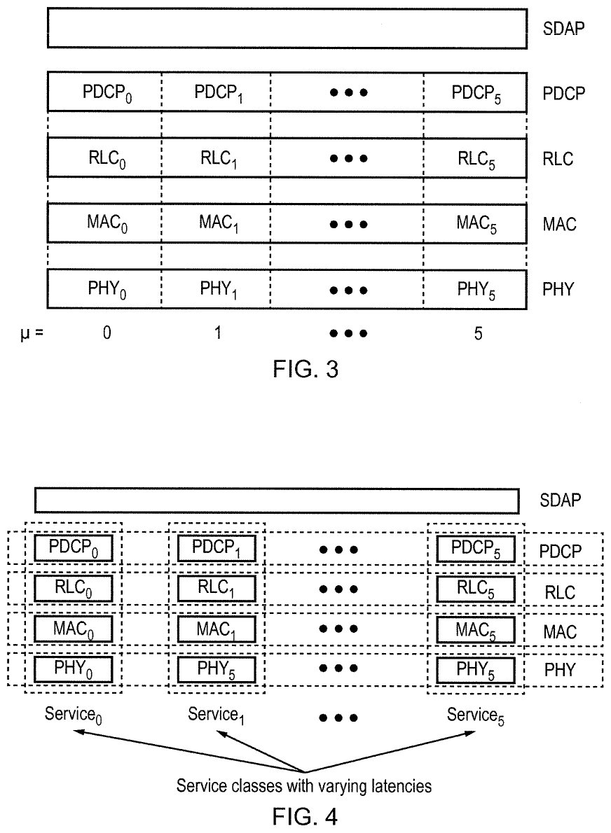

FIG. 3 shows a protocol stack of a RAN network split along different FFT lengths;

FIG. 4 shows how MicroServices supporting different latencies may be aligned with the vertical splitting of the protocol stack;

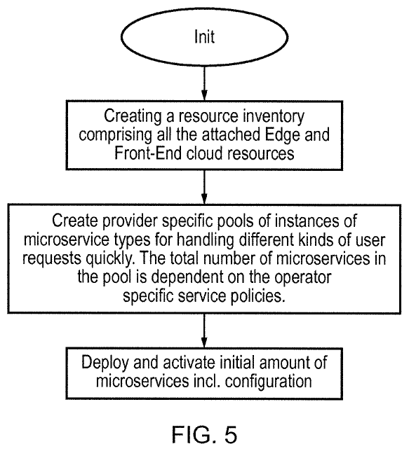

FIG. 5 shows a flow diagram illustrating steps in a method performed by a cloud resource controller;

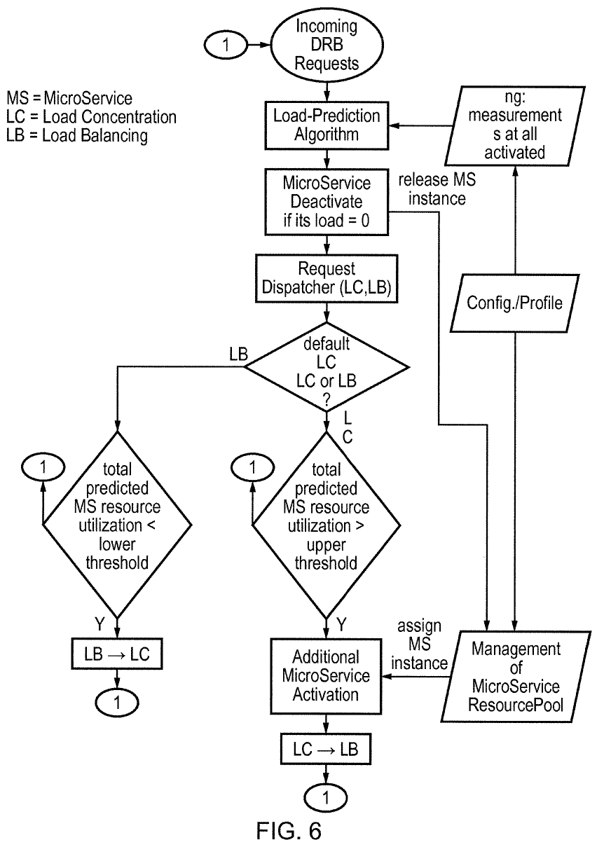

FIG. 6 schematically shows a method for updating cloud resource allocation according to load predictions;

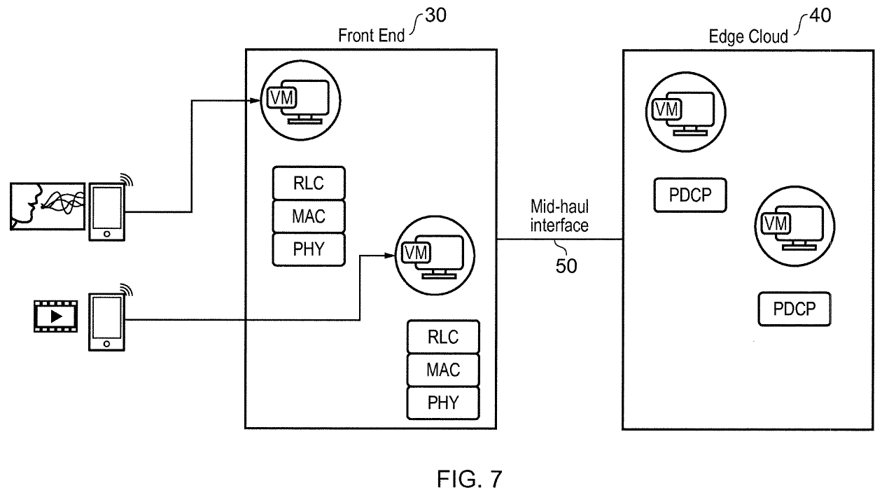

FIG. 7 shows multiple VNFs (virtualised network functions) for handling different services;

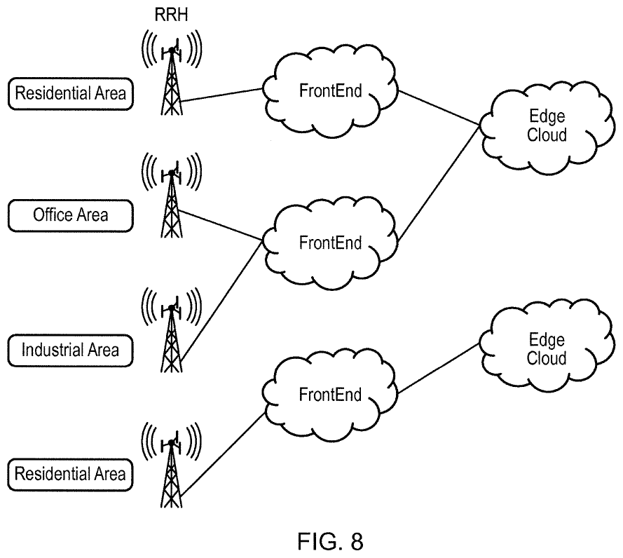

FIG. 8 shows front end edge cloud and radiohead deployments in CRAN; and

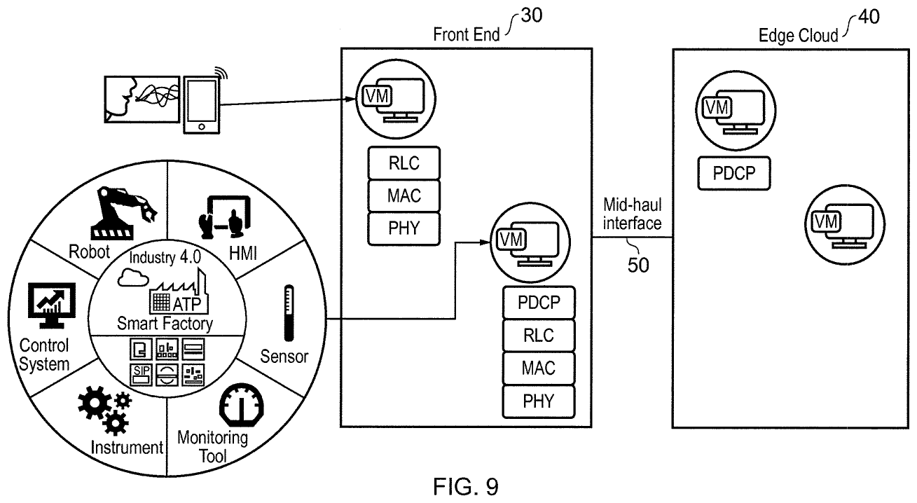

FIG. 9 shows MicroService pooling for handling different user requests.

### DETAILED DESCRIPTION

Before discussing the example embodiments in any more detail, first an overview will be provided.

A 5G Cloud RAN (radio access network) management system which operates on RAN specific KPIs (e.g. number of active users, types of service requests . . . ) may organize and manage pools of resources which may include ready to start RAN specific VNFs (virtualised network function e.g. virtualized micro services) or Reusable Function Blocks (RFBs) in a not only VNF environment (NoVNF). The VNFs can be put very quickly into operation in order to meet the scalability requirements of the 5G CRAN system. The size of the pools may be adapted according to resource consumption history and statistics. The pools may comprise already instantiated (ready to start) MicroServices which may be organized according to functionality and service provided, they may for example correspond to 5G network slices e.g. IoT (Internet of things), vehicular URLLC (ultra-reliable low latency cellular networks), factory of the future URLLC, health network mMTC (massive machine type communication) network slice. The pools may be adapted according to different load situation over a time period such as a day to increase memory and processor usage efficiency.

For runtime processing resource allocation, the VNFs may be structured to efficiently support load prediction methods predicting resource consumption of future requests. Resource consumption prediction is a recognized key feature for future 5G Cloud RAN systems to increase overall system performance and reactivity. To reduce the prediction error, one could put uniform types of VNFs (micro-services) onto a processing unit (CPU). The processing unit may contain a certain number of cores (e.g. 16 or 24). A VNF type may be a PDCP (packet data convergence protocol) MicroService using Docker virtualization technology. For different PDCP micro-service instances, at run time, an initial number of cores may be assigned to achieve the micro-service specific performance requirements (e.g. serve number of users) and scalability. The placement of uniform VNF type (e.g. PDCP only) to a single processing unit enables smaller prediction errors according resource consumption prediction.

FIG. 1 schematically shows circuitry according to an embodiment. Control circuitry 5, comprises resource management circuitry 10 and resource prediction circuitry 20 and this circuitry is configured to manage resources of a radio access network in order to supply services to a provider.

The network resources are in this example embodiment located in the front end unit 30 which is closer to the radioheads and in the edge cloud 40. The front end unit 30 and edge cloud 40 are interconnected via a mid-haul interface 50. The resources comprise general purpose processors, data storage, communication resources and in some cases special or single purpose processors configured to provide a particular functionality. The resources also include virtual machines, containers, reusable function blocks and/or executable files, that are configured to provide a particular functionality and are instantiated and ready to use.

The resource management circuitry 10 is configured to manage these resources in order to efficiently provide the services required by the provider. In this regard, the resource management circuitry 10 determines the resources available and the functionality required by one or more providers and splits the functionality required into predetermined functions relating to a particular service in a way that each functionality split provides a function that is cohesive, semi-autonomous and only loosely coupled to other functions. Each function is then provided with a pool of resources configured to perform this function. This pool of resources may be in the form of one or more executable files that is instantiated and ready to execute and provide the required functionality. This file may be a virtual machine or container. When activated and operational, programming, data storage and/or communication resources required for execution of the file are assigned to the pool of resources for providing that function, when deactivated and not operational but ready to use, these resources are freed and are available for use by other executable files within the pool of resources or within other pools.

The control circuitry 5 has prediction circuitry 20 which monitors the loading of the network and provides a prediction of which services and functions are likely to be required. This allows load balancing circuitry 12 within the resource management circuitry 10 to activate and deactivate resources for providing particular functions within particular resource pools, allowing for more efficient use of available resources. Providing predictions related to a particular pool or in some cases group of pools of resources, may allow more accurate predictions. In this regard the overall load of a network will depend on many factors as it provides many services to many different users, and the number of users and the type of services they require will change over time. However, particular services may be much easier to predict accurately and thus, predicting and managing resources on a pool or group of resource pools basis can both increase accuracy and be easier to perform.

In some embodiments, updating circuitry 14 is provided within resource managing circuitry 10 and this acts in conjunction with the load balancing circuitry 12 to update resources as required. In particular, the updating circuitry 14 preferentially updates resources when the load balancing circuitry has triggered a deactivated state, such that where possible updated occur without affecting the operation of the network.

It should be noted that in some example embodiments the control circuitry is on the front end, while in others it may be on the edge cloud, in still others it may be separate from both. In the example embodiment shown the control circuitry manages the circuitry on both the front end and edge cloud, in some cases separate control circuitry may manage resources on one or the other.

FIG. 2 show a flow diagram illustrating steps performed in a method according to an example embodiment. Initially the processing, data storage and communication resources available at the radio access network, or a subset of them that are to be managed by the resource management circuitry are determined. The services that are to be provided by the radio access network are also determined. In this regard this may be both the functions that are to be provided and the latency and/or quality of service that is required. Resources for supplying the services are then created. This may involve downloading software for providing a particular functionality and storing this as one or more executable files which when executed provide that functionality. The resources are then distributed or divided into pools, where each pool is configured to provide data handling for a different predetermined function. These functions may be cohesive functions that are loosely coupled to other functions. Where there are multiple functions that are closely coupled, these may be supplied by different executable files, which are then distributed to a same pool, or to different pools, the pools being grouped together such that the group is cohesive and loosely coupled to functions performed by other pools or groups of pools of resources.

The method may group the pools of resources together physically and/or logically. This grouping may be based on the service, so each pool in a group may perform different functions for the same service. In this case the loading for the pools in the group will vary together as the requirement for the service changes. The different functions in each pool may be functions performed in the different protocol layers of the network. In some cases the grouping may be according to latency. Where the grouping is physical then it may be appropriate to group lower latency services closer to the radioheads, so in the example of FIG. 1 in the front end rather than the edge cloud.

The method may also perform a load determining and/or prediction step and change the allocation of resources based on this step. In this regard the division of the resources into pools, and in some cases the grouping of the resource pools together may allow the loading of the pools to be more accurately predicted and in this way the available resources can be more accurately assigned to the required services. This allows the network to provide the required performance with fewer resources.

As background, cloud computing is a model for enabling ubiquitous, convenient, on demand network access to a shared pool of configurable computing resources (e.g., networks, servers, storage, applications, and services) that can be rapidly provisioned and released with low management effort or service provider interaction. Cloud radio access network is a novel architecture that performs the required baseband and protocol processing on centralized computing resources or cloud infrastructure. CRAN may extend the flexibility through abstraction (or virtualization) of the execution environment.

A CRAN cloud management system, should also take into account RAN KPI's such as number of users etc. Embodiments seek to use virtualized communication protocols to improve the options for efficient cloud resource management allowing MicroService orchestration, deployment, and configuration also at run time.

5G-CRAN communication protocols incorporate different resource requirements compared to general purpose applications. In principle applications or Apps can be executed on almost any server or client platform; however, telecommunication protocols specifically in the CRAN field uniquely require a minimum performance in some functions to meet the latency and throughput requirements. Therefore, dedicated HW is still a standard in the CRAN field.

With the concept of CRAN the approach is to put parts of the e.g. 5G stack on General Purpose Processing (GPP) platforms. With the dissemination of multi core platforms which enable for binding tasks (processes or threads) to a single core or a set of cores to enhance their performance, core affinity is a feature that needs to be considered in the field of cloud resource management

MicroServices are a new paradigm for software architecture which provide small services in separated processes to take the place of large applications. In this way monolithic architecture is avoided, and systems are easily scalable and changeable. MicroServices now are a new trend in software architecture, which emphasizes the design and development of highly maintainable and scalable software components. MicroServices manage growing complexity by functionally decomposing large systems into a set of independent services. By making services completely independent in development and deployment, MicroServices emphasize loose coupling and high cohesion by taking modularity to the next level. This approach delivers all sorts of benefits in terms of maintainability and scalability.

Recent 5G standardization has provided the following:
A set of 6 FFT lengths (μ=0 . . . μ=5) are introduced corresponding to 6 latency classes.
A new protocol layer named Service Data Adaptation Protocol (SDAP) has been introduced.

FIG. 3 shows the horizontal splitting into protocol layers of the functions provided by a 5G network along with the new vertical division of the functions into FFT lengths, whereby lower latency functions are provided with lower length FFTs.

The inventors recognized that the functionality and services offered by 5G could be viewed conventionally as functions provided by the different layers of the system, that is PDCP/RLC/MAC/PHY and it could also be viewed as being functions provided to perform particular services or requiring a particular latency. Additionally and/or alternatively it could be viewed as functions providing a particular error rate which may be a bit error rate (BER) or block error rate (BLER). Thus, functions may also be pooled and grouped according to the coding schemes they use which coding schemes provide different error rates depending on the requirements of the particular service. With regard to the latency requirements the introduction in 5G of different FFT lengths, provides an existing potential division of functions according to latency.

Embodiments seek to provide some of the required functionality using MicroServices. These can be selected to perform cohesive functions with particular QCI (quality of service class identifier) characteristics and latency classes which may correspond to FFT length. There may for example be a specific MicroService handling VoIP bearers only. This horizontal splitting of layers (e.g. VoIP PDCP) and vertical splitting according to the different 5G latency classes and the resulting MicroServices configured to perform these particular selected functions may improve performance, latency and reduce complexity. Moreover, such distribution of tasks to particular pools of resources allows prediction about resource consumption and scaling behavior observation to be more accurate and precise due to more homogenous (types of) requests. The virtualized MicroServices may be optimized for the specific bearer type (QCI) and control plane and specific preferred split options (vertical splits) and may be deployed on demand at Edge Cloud (Central Unit) and FrontEndUnit (Distributed Unit).

The advantages may include less complexity and improved performance, more predictive scaling and dedicated horizontal and vertical split options. Moreover, to maintain and optimize small specialized MicroServices is much more effective than maintaining a complex layer which serves totally different service classes and latency classes. Single modifications do not influence an entire layer (e.g. PDCP) or protocol stack or different services and latency classes. Modification and bug fixing within a single MicroService leads to a fast dedicated deployment of the affected single MicroService only and avoids significant system down time resulting in increased system maintainability.

A possible specific MicroService type could be e.g. GBR MAC or GBR PHY or NGBR MAC or NGBR PHY as well as Ultra Low Latency MicroServices. Another specific micro service type could be Massive IoT or Critical IoT MAC/PHY for dedicated to a low latency class or (QCI 8/9) Buffered Streaming MAC/PHY etc.

The scheduler may be subdivided into service oriented parts and a cell oriented part. The service oriented schedulers scale with the number of users and may be also specific to the different QCI characteristics and bearer request types. The short (low latency) TTIs may become scheduled (cell oriented) by default in the front-end unit and the legacy TTIs in the edge cloud, including appropriate baseband partitioning.

FIG. 4 schematically shows how the services provided by the radio access network may be divided and how the FFT length can be related to services with specific latency requirements. In embodiments, specific MicroServices or resources configured to provide functions related to a particular vertical and horizontal split may be provided.

In example embodiments, a clustering of cloud resources is provided for specific PDCP/RLC/MAC/PHY micro services relating to different functions of a particular service, user QCI or 5G standard 5QI characteristics. For example, there could be a specific micro service handling VoIP bearers only. This horizontal splitting of layers (e.g. VoIP PDCP) into so-called micro services may improve performance, latency and lower complexity. Moreover, prediction about scaling behavior can be more precise due to the homogenous requests on the specific MicroService. These MicroServices could be optimized for the specific bearer type and specific preferred split options (vertical splits) and may be deployed at Edge Cloud and Front End. The advantages may include less complexity and more predictive scaling and more efficient split options.

The scheduler may be subdivided into user oriented parts and a cell oriented part. The user oriented schedulers scale with the number of users and may be also specific to the different QCI (or 5QI) characteristics and bearer request types. The short TTIs (transmit time intervals) become processed by default in the front-end unit and the legacy TTIs in the edge cloud.

The flowchart (FIG. 5) schematically shows a 5G MicroService resource management system. It illustrates how MicroService become activated and deactivated depending on MicroService resource usage. In the initialization (init) phase all resources on the edge cloud and front end unit are stored in an overall resource inventory. This inventory creation helps to inform decisions taken about the initial microservice pool creation.

Pools of uniform MicroService types with service specific processing resource (core) assignment are then created for handling specific user requests (DRBs) quickly and efficiently. Each microservice pool may be assigned to handle specific types of user requests e.g. one pool can handle only VoIP request, another pool may handle only latency sensitive or short TTI, IoTs etc. As we have already discussed, the advantage of segmentation of MicroServices for handling dedicated user requests, allows for better prediction about future traffic and also allows improved resource usage. In the case that the cloud resource amount (in both Edge and FrontEnd) doesn't meet a certain threshold, the operator may decide to go for a lower number of microservice pools. Moreover, deployment and activation of an initial amount (operator specific) of MicroServices including configuration at EC and FEU includes placing of the services with lower latency MicroService pools being placed on the FEUs and higher latency sensitive MicroServices to the EC.

The input requests (DRB requests) will be dispatched (Load Concentration (LC) or Load Balancing (LB)) to a dedicated MS pool containing activated MicroServices of a certain type according to the request type (e.g. latency class). The lightweight load prediction algorithm estimates the resource consumption and then the predicted total resource usage is checked against a threshold to switch between Load Balancing and Load Concentration dispatching strategy applied within the pool.

This is illustrated in FIG. 6. If the system hits the upper threshold which means that the overall resource usage of a current MS pool (size) becomes critical (too high) the system will assign an additional MS instance to the current activated MS pool and the load will be balanced.

If the system hits the lower threshold which means that the overall resource usage of current MS pool (size) becomes too little the system switches from load balancing to load concentration and this may lead to emptying a single MicroServices which can be released to the MS pool. In this regard the processing and/or data storage resource assigned to an operational MS, is reassigned to the pool while the MS is not operational.

The requests that had been serviced by the deactivated MS will be distributed to other operational MS within the pool. The pool containing uniform types of MicroServices depending on the request type (e.g. latency type). Within a pool the traffic will be balanced or concentrated depending on the resource usage of the pool and scalability is performed by quick and efficient assignment or release of MS instances of a certain type.

In summary by providing resources for particular functions relating to a particular service, and in some cases, by clustering resources by the latency of a function the allocation of resources can be prioritised according to network requirements and KPIs in a straightforward manner. Thus, the problem of processing overload is addressed in a straightforward manner and can be done with no or at least very low impact on service related timing. Things that need not necessarily be coupled are kept separately and can be separately controlled. It provides “loose coupling” between different types of resources, such radio resources, processing resources and network resources (e.g. Midhaul bandwidth resources).

In addition to loose coupling between different types of resources, loose coupling between different resource schedulers such as air interface scheduler, standard OS scheduler performing scheduling mainly of computing resources and network operating system (NOS, SDN) scheduling network resources is also proposed.

A compartmentalised service handling system is provided with in some embodiments dedicated pools for handling particular service types. Different kinds of services can be distinguished by the types of the request and KPIs e.g. QCI (or 5QI), GBR, NGBR, Channel quality, latency sensitivity etc. FIG. 7 shows how multiple NFVs are provided on the front end 30 and edge cloud 40, each for handling different services. The user requests are distributed to the different NFVs according to the service they request. It should be noted that although NFVs in the form of VMs are shown, there may be a mix of VMs, dedicated hardware and reusable function blocks.

As the NFVs don't have to process different kinds of traffic mix, the transient effect or the spikes in the computation effort consumption can be reduced. Moreover, a prediction algorithm may be able to generate more reliable results. With this approach we are able to predict the traffic increase in advance and take mitigating actions. Furthermore, this approach also reduces the run time deployment complexity and provides better handlings of latency sensitive of IoTs.

FIG. 8 shows how in CRAN different FrontEnds 30 support different areas. The cell size can be dimensioned based on the number of users. That means if the user density is higher, then the area covered by the cell might be reduced and vice versa.

Furthermore, different users have different movement and service requirement characteristics. To maintain the service specific KPIs the operator has conventionally done a horizontal RAN slicing according to protocol layers. In CRAN architecture the operators may deploy MicroServices according to these slicing decisions. Were all the users to be processed using a single MicroService, the system would be complex to handle and the operator will lose pooling gain.

To address these potential difficulties embodiments provide MicroService pools for different service class (QCI, 5QI, GBR, NGBR etc.). Incoming new DRB requests are distributed according to the types of service. In FIG. 9 the different segmenting of user requests and mapping to a particular pool of resources is illustrated. Thus, VoLTE DRB (voice over LTE data radio bearer) requests are shown as being placed to a specific MicroService pool. As this pool is processing only specific service (VoLTE), each MicroService has special configuration (RLC (radio link control) that is running in UM mode, MAC has Semi-Persistent Scheduling (SPS) and so on).

The same FrontEnd 30 may also process URLLC IoTs (FIG. 9). In this case the operator may also use specific MicroService pool dedicated to this service class (MAC needs a different scheduler where the TTI length might be 100 μs).

As these are some high priority sensitive services, operators maintain the KPIs by close observation of system behavior. The CPU consumption or load may be continuously monitored. Based on the current load and prediction output the algorithm enters into either Load Balance (LB) or Load Concentration (LC) mode. In case of LB, if the load is too small then the algorithm enters into LC mode, otherwise it runs with current system configuration. In LC mode it checks (both current load situation and prediction) the current system behavior. If no action is needed, then it enters into load balance mode otherwise it may go for a new deployment of a MicroService instance (higher load) or delete an old MicroService (lower load).

The operator may define a close distance “upper threshold” and “lower threshold” (FIG. 6), to make the system more interactive for sensitive services e.g. VoLTE, URLLC IoT. Alternatively, they can go for the bigger distance “upper threshold” and “lower threshold” traditional services e.g. MBS, to make the system more relaxed and to achieve more pooling gain.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method of managing resources within a cloud radio access network for performing baseband and protocol processing, the method comprising:
distributing at least some of a plurality of resources into a plurality of pools of resources, each of said pools of resources being configured to provide data handling for a different predetermined function, each predetermined function relating to a service provided by said radio access network; and
managing at least some of said pools of resources in dependence upon the performance requirements of said corresponding service.

2. A method according to claim 1, further comprising distributing user requests to respective ones of said plurality of pools in dependence upon said service requested and said function to be performed.

3. A method according to claim 1, wherein said predetermined function comprises an autonomous or semi-autonomous function processing for which can be performed with low interaction with other resources.

4. A method according to claim 1, wherein each of said pools comprises at least one resource configured to provide said predetermined function on demand.

5. A method according to claim 4, wherein at least one of said at least one resource comprises a pre-instantiated executable file configured on execution to provide said predetermined function.

6. A method according to claim 4, wherein at least one of said at least one resource comprises a special purpose processor configured to provide said predetermined function.

7. A method according to claim 1, wherein said managing further comprises in response to detecting or predicting changes in loading of said service on said network, switching at least one resource within a pool configured to provide data handling for a predetermined function related to said service between an activated state in which said resource is operational and performing said predetermined function and a deactivated state where said resource is available to the pool on request but is not currently operational.

8. A method according to claim 4, comprising allocating at least one of processor, communication and data storage resource to said at least one resource on activation of said at least one resource and releasing said allocated at least one of processor, communication and data storage resource on deactivation of said at least one resource.

9. A method according to claim 1, comprising:
in response to a request for updating said predetermined function, said step of managing comprises updating a resource within said pool of resources configured to perform said predetermined function when said resource is in a deactivated state.

10. A method according to claim 1,
comprising a further grouping at least some of said pools into groups of pools of resources providing a same service, wherein said managing comprises managing at least some of said groups of pools of resources in dependence upon requirements of said corresponding service.

11. A method according to claim 10,
wherein at least some of said pools are grouped into groups of pools of resources, each pool providing one of: a different protocol layer of said service and a different function of said service.

12. A method according to claim 10,
wherein at least some of said pools are grouped into one of: groups of pools of resources according to a latency requirement of said service, pools of resources with similar latency requirements being grouped together; groups of pools of resources using a same data coding scheme; and groups of pools of resources with a same FFT length.

13. A method according to claim 10,
wherein at least some of said groups of pools are located on a same central processing unit.

14. A method according to claim 10,
wherein groups of pools with a low latency requirement are located in a front end unit and groups of pools with a higher latency requirement are located in an edge cloud unit.

15. A method according to claim 1, said managing further comprises predicting future resource requirement for at least some of said pools.

16. A method according to claim 15, wherein in response to said predicting indicating that the predicted usage of processing resources within one of said pools is to fall below a predetermined threshold changing at least one of said processing resources within said pool from an activated state in which said resource is operational and performing said predetermined function and a deactivated state where said resource is available to the pool on request but is not currently operational.

17. A method according to claim 15, wherein in response to predicting indicating that the predicted usage of processing resources within one of said pools is to rise above a predetermined threshold changing at least one of said processing resources within said pool from a deactivated state where said resource is available to the pool on request but is not currently operational to an activated state in which said resource is operational and performing said predetermined function.

18. A method according to claim 1, comprising an initial determining processing, data storage and communication resources available to said network and including said determined available resources in said plurality of resources.

19. A method according to claim 1, comprising receiving information from a provider of services indicating services and performance requirements for said services that said provider seeks to provide from said radio access network;
distributing said plurality of resources into pools to provide functions related to said services in dependence upon the received information.

20. Circuitry providing resources within a cloud radio access network for performing baseband and protocol processing, said circuitry comprising:
a plurality of resources said resources including general purpose processors configured to provide processing resources for said radio access network;
said circuitry comprising resource managing circuitry configured to manage said plurality of resources by distributing at least some of said plurality of resources into a plurality of pools of resources, each of said plurality of pools of resources being configured to provide data handling for a different predetermined function, each predetermined function relating to a service provided by said radio access network;
wherein at least some of said pools of resources are to be managed in dependence upon the performance requirements of said corresponding service.

21. A computer program comprising instructions for causing an apparatus to perform a method according to claim 1.
